(19) United States
(12) Patent Application Publication
(10) Pub. No.: US 2008/0103688 A1
(43) Pub. Date: May 1, 2008

(54) METHOD AND SYSTEM FOR A TRAVEL ROUTE PREFERENCE REPOSITORY BASED ON GPS SERVICES

(75) Inventors: David M. Chess, Mohegan Lake, NY (US); David B. Flaxer, Port Hadlock, WA (US); Mary E. Helander, North White Plains, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/554,155

(22) Filed: Oct. 30, 2006

(51) Int. Cl. G01C 21/32

(52) U.S. Cl. 701/202; 701/210; 340/995.19

(57) ABSTRACT

A system and method for a travel route preference repository based on global positioning services (GPS). The system includes an information input member being configured to accept input information from users of the system. The input information is an evaluation of routes that the users have traversed. An information correlation member is communicatively connected via a network to the information input member. The information correlation member is configured to render a response pertaining to the input information such that users that have not entered an evaluation of the routes may have a current evaluation of the routes. An information access member is communicatively connected via the network to the information input member and the information correlation member. The information access member is configured to permit users of the system to have access to the response of the information correlation member.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to repositories, and more particularly to a travel route preference repository.

2. Description of Background

Many modern day vehicles have navigation systems that incorporate global positioning technology in order to assist drivers with directions during their traveling. Such systems generally display graphical illustrations of the user's desired route. By “vehicles,” we mean any transportation system including but not limited to automobiles, motorcycles, bicycles, boats, etc. Given the state of global positioning system (GPS) technology, a vehicle may also include a mobile person such as a person walking or hiking to which a GPS receiver is attached. Accordingly, a “driver” is defined as a person operating a vehicle.

Today's vehicles generally incorporate “breadcrumbing” functionality via GPS technology. “Breadcrumbing,” is the functionality of utilizing GPS technology to track the geographic progress of a vehicle over time. Breadcrumbing is currently utilized in the commercial trucking industry and may be implemented and utilized within telematics solutions for these vehicles.

Yet, no vehicle possesses a navigation system that may be used to capture route attributes, and build searchable route data that may be queried to help construct routes with certain preferences. For example, building a route predicated upon safety, or building a route possessing quality scenic views and scenic stops, or building a route wherein the road traveled possesses an average decline of ten percent (10%), or where a river can support a boat of a given class throughout a given route. Currently, routes are built either on attributes such as distance; for example, building a route that possesses the shortest path from destination A to destination B. Another example includes building a route that is commonly shared as a whole by many travelers such as a country route through a particular county that yields a great motorcycle or bicycling route.

Thus, there is a need for a method and a system that provides the user with accurate information that is sufficient enough to allow the user (the route planner) to make decisions based on a full slate of preferences. Furthermore, such system should provide the route planner with the ability to efficiently identify routes that meet all their requirements.

### SUMMARY OF THE INVENTION

The shortcomings of the prior art are overcome and additional advantages are provided through the provision of a system for a travel route preference repository based on global positioning services (GPS). The system includes an information input member being configured to accept input information from users of the system. The input information being an evaluation of routes that the users have traversed. The system further includes an information correction member being communicatively connected via a network to the information input member. The information correlation member is configured to render a response pertaining to the input information such that users that have not entered an evaluation of the routes may have a current evaluation of the routes. The system further includes an information access member being communicatively connected via the network to the information input member and the information correlation member. The information access member is configured to permit users of the system to have access to the response of the information correlation member. The response rendered by the information correlation member is at least one of, (i) a high evaluation representing a good route to travel, and (ii) a low evaluation representing a poor route to travel.

The shortcomings of the prior art are overcome and additional advantages are provided through the provision of a method for a travel route preference repository based on global positioning services (GPS). The method includes inputting input information that represents an evaluation of routes traveled by users. The method further includes rendering a response regarding the input information such that users that have not entered an evaluation of the routes may have a current evaluation of the routes. Subsequently, the method includes permitting users to have access to the rendered response. The response rendered by the information correlation member is at least one of, (i) a high evaluation representing a good route to travel, (ii) a low evaluation representing a poor route to travel.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution for a system and a method for a travel route preference repository based on global positioning services.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for a travel route preference repository based on global positioning services;

FIG. 2 illustrates one example of a response rendered by the system shown in FIG. 1;

FIG. 3 illustrates one example of a map rendered by the system shown in FIG. 1; and

FIG. 4 illustrates one example of a method for a travel route preference repository based on global positioning services.

The detailed description explains an exemplary embodiment of the invention, together with advantages and features, by way of example with reference to the drawings.

### DETAILED DESCRIPTION OF THE INVENTION

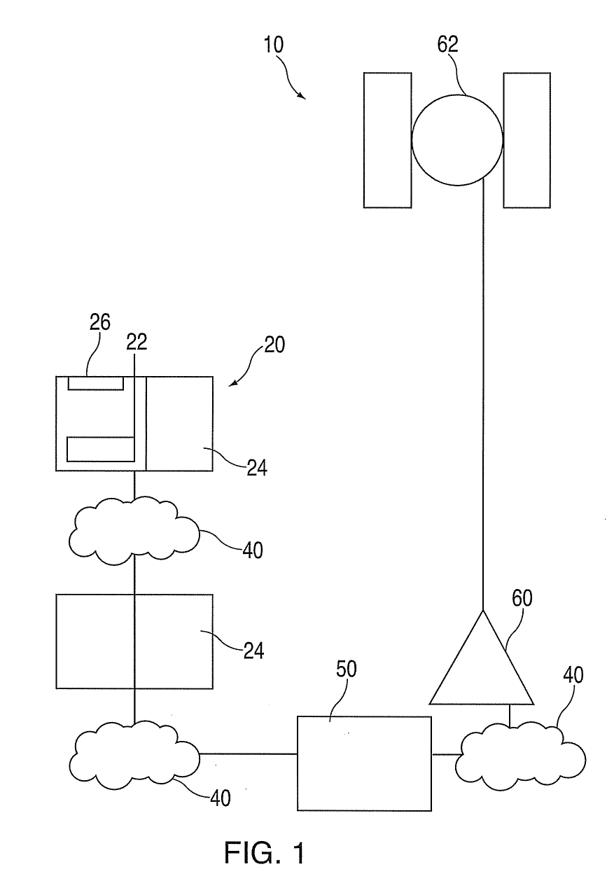

Referring to FIG. 1, a system 10 for a travel route preference repository based on global positioning is shown. The system 10 includes an information input member 20 being configured to accept input information from users of the system 10. The input information includes an evaluation of routes that the users have traversed. Additionally, the input information is utilized to determine the physical locations traversed by the users of the route. The user may segment the route and assign particular attributes to each segment. Each segment may be for any size desired by the user and multiple segments are combined to form a route. The combined/collective attributes of the route are a function of the attributes corresponding to its segments.

The information input member 20 includes at least one of a keypad member 22, a touch screen member 24 and a voice-receiving module 26. Keypad member 22 allows for manually entering input information. Touch screen member 24 allows for at least one of manually entering input information, and displaying graphical location illustrations of the user location. Voice recording module 26 allows for verbally entering the input information, and for providing verbal narratives pertaining to the routes being traversed by the user. After route traversal, the user may optionally input their desired attributes into the system 10 via the graphical interface on the computer that allows him/her to review the route and add appropriate attributes to segments and points located on the route.

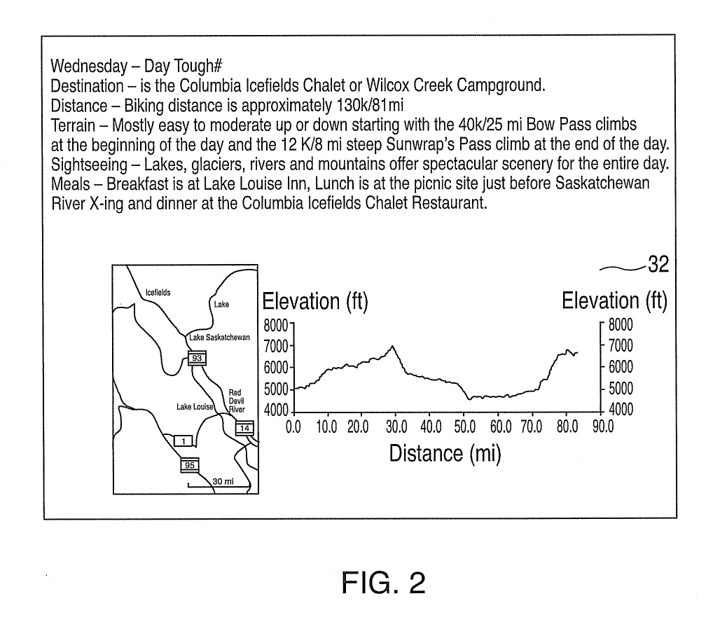

Referring to FIGS. 1 and 2, the system 10 further includes an information correlation member 30 being communicatively connected via a network 40 to the information input member 20. The information correlation member 30 is configured to render a response 32 pertaining to the input information such that users that have not entered an evaluation of the routes may have a current evaluation of the routes. The information correlation member 30 is further configured to render an evaluation of the quality of the route on at least one dimension. The information correlation member 30 is further configured to render a response 32 based upon the user specifying a particularly trip pattern. The system 10 is configurable to permit users to trace the routes traversed by previous users over time.

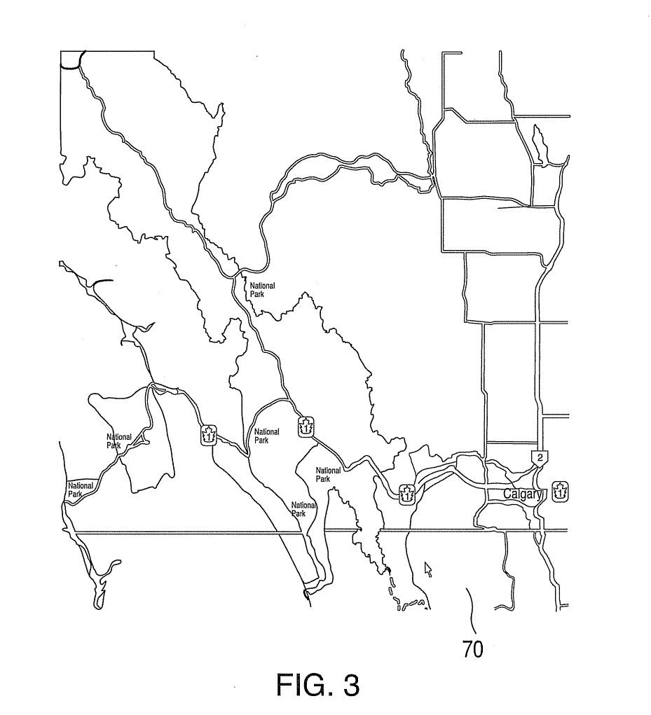

The information correlation member is configurable to render a response 32 that predicts how much a particular user shall like or dislike a route. The response 32 being predicated upon information input via other users', such input information expressing their preferences. The response also incorporates the particular user's expressed preferences, both the users' and the particular user's preferences can be correlated or non-correlated in a positive or a negative manner. Referring to FIG. 3, a map 70 is shown. The information correlation member is configured to render the map 70 with preference attributes from the user such that the map 70 can be used as the instructional tool followed by the traveler.

Additionally, the system 10 includes an information access member 50 communicatively connected via the network 40 to the information input member 20 and the information correlation member 30. The information access member 50 includes a database of travel routes and evaluations of routes from travelers of those routes. The information access member 50 is configured to permit users of the system 10 to have access to the response 32 of the information correlation member 30.

The response 32 rendered by the information correlation member 30 is at least one of: (i) a high evaluation representing a good route to travel, and (ii) a low evaluation representing a poor route to travel.

The system 10 further includes a global positioning receiver 60 being communicatively connected via the network 40 to a global positioning system 62 (GPS). The global positioning receiver 60 is also communicatively connected to the information input member 20, the information correlation member 30, and the information access member 50. The GPS 62 is utilized to pinpoint the exact location of the user.

As should be known by one skilled in the art, the data collected by the system 10 may be collected in real time, or collected after the user traverses the route. For example and not meant to be limiting, real time data collection may include utilizing a voice recording or digital indicator that is associated with bread-crumbing data being collected.

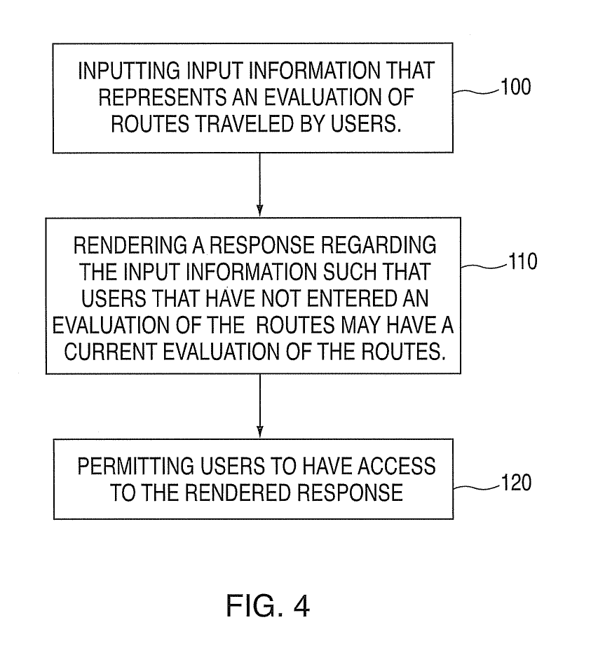

Referring to FIG. 4, a method for a travel route preference repository based on global positioning is shown.

At step 100, input information is input that represents an evaluation of routes traveled by users. For example, a traveler may be traversing a route and desire to submit an evaluation of the route. Through information input device 20, the user can submit an evaluation of the route through text or voice. As the GPS coordinates of the information input device 20 are known, the information access member 50 can store comments along the geographic coordinates.

Subsequently, at step 110, user requests information on a route and a response is rendered pertaining to the input information such that users that have not entered an evaluation of the routes may have a current evaluation of the routes. For example, a user may submit a request for a route having scenic views through the information input device 20. The location of the user is known from the GPS coordinates of the information input device 20. The information correlation member 30 may then search information access member 50 for routes within a certain range of the user that include an evaluation defining a scenic view.

Then, at step 120 users are permitted to have access to the rendered response. The response rendered by the information correlation member 30 is at least one of: (i) a high evaluation representing a good route to travel, and (ii) a low evaluation representing a poor route to travel. The evaluation of the travel route corresponds to how all the travel route meet the user's search criteria (e.g., scenic view, shortest distance, etc.)

The disclosed method allows the user to pinpoint via GPS their exact location when traveling. The user may also determine the physical locations traversed by other users of the route. An evaluation of the quality of the route may be rendered on at least one dimension. Furthermore, a response may be rendered based upon the user specifying a particular trip pattern. Additionally, users are permitted to trace the routes traversed by previous users of the same route over time.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for a travel route preference repository based on global positioning services (GPS), comprising:
an information input member configured to accept input information from users of the system, the input information being an evaluation of routes that the users have traversed;
an information correlation member communicatively connected via a network to the information input member, the information correlation member configured to render a response pertaining to the input information such that users that have not entered an evaluation of the routes may have a current evaluation of the routes;
an information access member communicatively connected via the network to the information input member and the information correlation member, the information access member configured to permit users of the system to have access to the response of the information correlation member; and
wherein the response rendered by the information correlation member is at least one of, (i) a high evaluation representing a good route to travel, and (ii) a low evaluation representing a poor route to travel.

2. The system of claim 1, further including a global positioning receiver communicatively connected via the network to a global positioning system (GPS), the information input member, the information correlation member and the information access member.

3. The system of claim 2, wherein the GPS is utilized to establish the location of the user.

4. The system of claim 3, wherein the input information is utilized to determine the physical locations traversed by the users of the route.

5. The system of claim 4, wherein the information correlation member is further configured to render an evaluation of the quality of the route on at least one dimension.

6. The system of claim 5, wherein the information correlation member is further configured to render a response based upon the user specifying a particular trip pattern.

7. The system of claim 6, wherein the information correlation member is further configured to render a response that predicts how much a particular user shall at least one of, (i) like, and (ii) dislike a route, the response being predicated upon other users' expressed preferences and the particular user's expressed preferences, both the users' and the particular user's preferences being at least one of, (a) correlated, and (b) non-correlated.

8. The system of claim 7, wherein the information correlation member is further configured to render a map with preference attributes such that the map shall be the instructional tool followed by the traveler.

9. The system of claim 8, being further configured to permit users to trace the routes traversed by previous users over time.

10. The system of claim 9, wherein the information input member includes at least one of, (i) a keypad member for manually entering input information, (ii) a touch screen member for at least one of, (a) manually entering input information, and (b) displaying graphical location illustrations of the user location, and (iii) a voice recording module for at least one of, (c) verbally entering the input information, and (d) for providing verbal narratives pertaining to the routes being traversed by the user.

11. The system of claim 10, wherein the user may segment the route and assign particular attributes to each segment, such segments may be for any size desired by the user.

12. The system of claim 11, wherein the data collected via the information input information member is at least one of, (i) collected in real time and, (ii) collected after the user traverses the route.

13. A method for a travel route preference repository based on global positioning services (GPS), comprising:
inputting input information that represents an evaluation of routes traveled by users;
rendering a response regarding the input information such that users that have not entered an evaluation of the routes may have a current evaluation of the routes;
permitting users to have access to the rendered response; and
wherein the response rendered by the information correlation member is at least one of, (i) a high evaluation representing a good route to travel, and (ii) a low evaluation representing a poor route to travel.

14. The method of claim 13, further including:
pinpointing the location of the user.

15. The method of claim 14, further including:
determining the physical locations traversed by the users of the route.

16. The method of claim 15, further including:
rendering an evaluation of the quality of the route on at least one dimension.

17. The method of claim 16, further including:
rendering a response based upon a user specifying a particular trip pattern.

18. The method of claim 17, further including:
permitting users to trace the routes traversed by previous users over time.
